(19) United States
(12) Patent Application Publication
(10) Pub. No.: US 2025/0355515 A1
(43) Pub. Date: Nov. 20, 2025

(54) ELECTRONIC DEVICE WHICH CAN RECORD MACRO AND MACRO RECORDING METHOD

(71) Applicant: PixArt Imaging Inc., Hsin-Chu City (TW)

(72) Inventor: Jr-Yi Li, Hsin-Chu City (TW)

(73) Assignee: PixArt Imaging Inc., Hsin-Chu City (TW)

(21) Appl. No.: 18/666,795

(22) Filed: May 16, 2024

(51) Int. Cl. G06F 3/038; A63F 13/235; G06F 3/0354; G06F 3/0487

(52) U.S. Cl. CPC G06F 3/0383; G06F 3/03543; G06F 3/0487; A63F 13/235; G06F 2203/0381; G06F 2203/0384

(57) ABSTRACT

An electronic device, comprising: a storage device; and a processing circuit, configured to acquire first macro codes of first macro steps provided by a source device, and configured to record the first macro codes to the storage device, wherein the source device is independent from the electronic device; wherein the electronic device further outputs the first macro codes to a target device such that the target device replays a macro corresponding to the first macro steps.

### BACKGROUND OF THE INVENTION

### 1. Field of the Invention

The present invention relates to an electronic device which can record macros and a macro recording method, and particularly relates to an electronic device which can record macros and a macro recording method which can record macros provided by another device.

### 2. Description of the Prior Art

A conventional optical mouse may record a macro which comprises a plurality of macro steps. Macros provide users with convenient operations, especially in a game. For example, a user may trigger a function or a menu of the game by clicking the right button for one time, then clicking the left button for three times and then pressing a middle button. However, if a macro comprising the above-mentioned three macro steps is pre-recorded in the optical mouse, the user can trigger the function or the menu only via clicking one button of the optical mouse to replay the macro. However, the conventional optical mouse only can record macro steps performed by itself, thus the combinations and application scopes of macros are limited.

### SUMMARY OF THE INVENTION

One objective of the present invention is to provide an electronic device which may record macro provided by itself or by another electronic device.

Another objective of the present invention is to provide a macro recording method which may record macro provided by itself or by another electronic device.

One embodiment of the present invention discloses an electronic device, comprising: a storage device; and a processing circuit, configured to acquire first macro codes of first macro steps provided by a source device, and configured to record the first macro codes to the storage device, wherein the source device is independent from the electronic device; wherein the electronic device further outputs the first macro codes to a target device such that the target device replays a macro corresponding to the first macro steps.

Another embodiment of the present invention discloses a macro recording method, applied to an electronic device comprising a storage device and a processing circuit, comprising: acquiring first macro codes of first macro steps provided by a source device by the processing circuit; recording the first macro codes to the storage device by the processing circuit, wherein the source device is independent from the electronic device; and outputting the first macro codes to a target device by the electronic device such that the target device replays a macro corresponding to the first macro steps.

In view of above-mentioned embodiments, an electronic device may record macro provided by itself or by another electronic device. By this way, the combinations and application scopes of macros can be extended.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a macro recording operation according to one embodiment of the present invention.

FIG. 2 is a block diagram illustrating details of the optical mouse in FIG. 1, according to one embodiment of the present invention.

FIG. 3 is a schematic diagram illustrating a code format of the first macro codes according to one embodiment of the present invention.

FIG. 4, FIG. 5 and FIG. 6 are examples of first macro codes and second macro codes, according to embodiments of the present invention.

FIG. 7 is a flow chart illustrating an encoding operation according to one embodiment of the present invention.

FIG. 8 is a flow chart illustrating a decoding operation according to one embodiment of the present invention.

FIG. 9 is a flow chart illustrating a macro recording method according to one embodiment of the present invention.

### DETAILED DESCRIPTION

In the following descriptions, several embodiments are provided to explain the concept of the present application. The term “first”, “second”, “third” in following descriptions are only for the purpose of distinguishing different one elements, and do not mean the sequence of the elements. For example, a first device and a second device only mean these devices can have the same structure but are different devices.

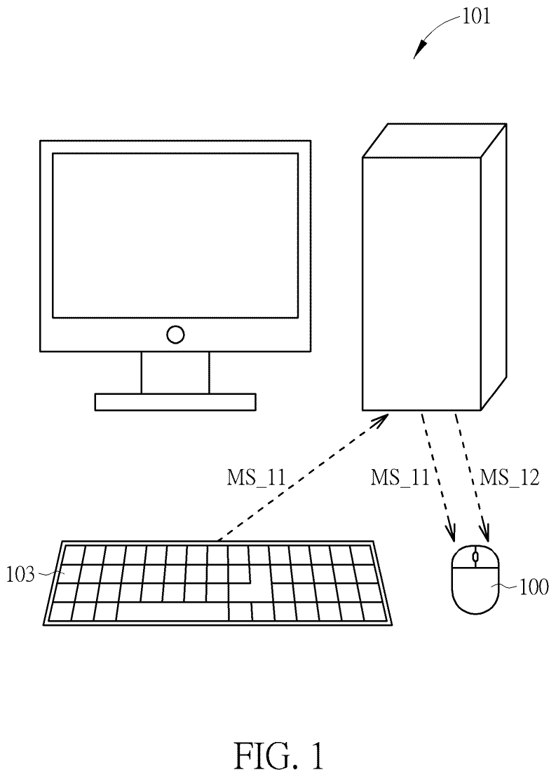

FIG. 1 is a schematic diagram illustrating a macro recording operation according to one embodiment of the present invention. In the embodiment of FIG. 1, the optical mouse 100 acquires first macro codes of first macro steps provided by a source device independent from the optical mouse 100, and records the first macro codes to a storage device therein. The optical mouse 100 may further outputs the first macro codes to a target device such that the target device replays a macro corresponding to the first macro steps.

In one embodiment, the target device is a computer 101, and the source device is a HID device which has a wireless connection or a wired connection with the target device. For example, the HID device is a keyboard 103, which provides first macro steps MS_11 to the computer 101 and then the computer 101 transfers the first macro steps MS_11 to the optical mouse 100. In such case, the first macro steps MS_11 may be the pressing or releasing of buttons of the keyboard 103. However, the first macro steps MS_11 may be different for different HID devices.

In another embodiment, the target device is the computer 101 which also serves as the source device. For example, in the embodiment of FIG. 1, the computer 101 provides first macro steps MS_12 to the optical mouse 100. In such case, first macro steps MS_12 may be steps for executing at least one program stored in the computer 101. For example, the first macro steps MS_12 may be steps for executing calculator software stored in the computer 101. It will be appreciated that in the embodiments of the present invention, the steps of providing or receiving macro steps may mean providing or receiving signals or data which represent the macro steps.

After receiving the first macro steps, the optical mouse 100 may transform the first macro steps to first macro codes. However, the steps of transforming the first macro steps may be performed by the computer 101 which serves a host device of the optical mouse 100. Accordingly, the above-mentioned step “transferring first macro steps MS_11, MS_12 to the optical mouse 100” may be replaced by “transferring first macro codes of first macro steps MS_11, MS_12 to the optical mouse 100”. Additionally, besides the macro steps provided by the source device, the optical mouse 100 may also records macro steps performed by itself. In such case, the optical mouse 100 is further configured to acquire second macro codes of second macro steps performed by the optical mouse 100 and configured to record the second macro codes to the storage device.

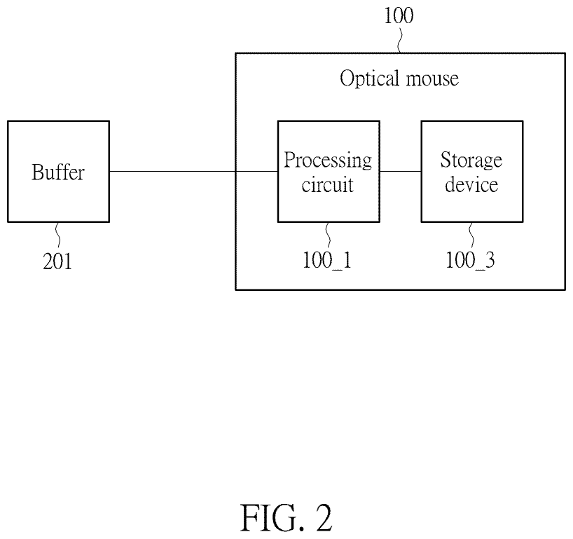

FIG. 2 is a block diagram illustrating details of the optical mouse in FIG. 1, according to one embodiment of the present invention. As shown in FIG. 2, the optical mouse 100 comprises a processing circuit 100_1 and a storage device 100_3. The processing circuit 100_1 is configured to receive the above-mentioned first macro steps, the first macro codes, the second macro steps or the second macro codes from the buffer 201. The storage device 100_3 is configured to store the first macro codes or the second macro codes. The buffer 201 is configured to buffer the above-mentioned first macro steps, the first macro codes, the second macro steps or the second macro codes before these data are stored to the storage device 100_3, or before these data are transferred to the computer 101. The buffer 201 may be provided inside the optical mouse 100. Alternatively, the buffer 201 may be provided outside the optical mouse 100. For example, the buffer 201 may be provided in the computer 101 in FIG. 1.

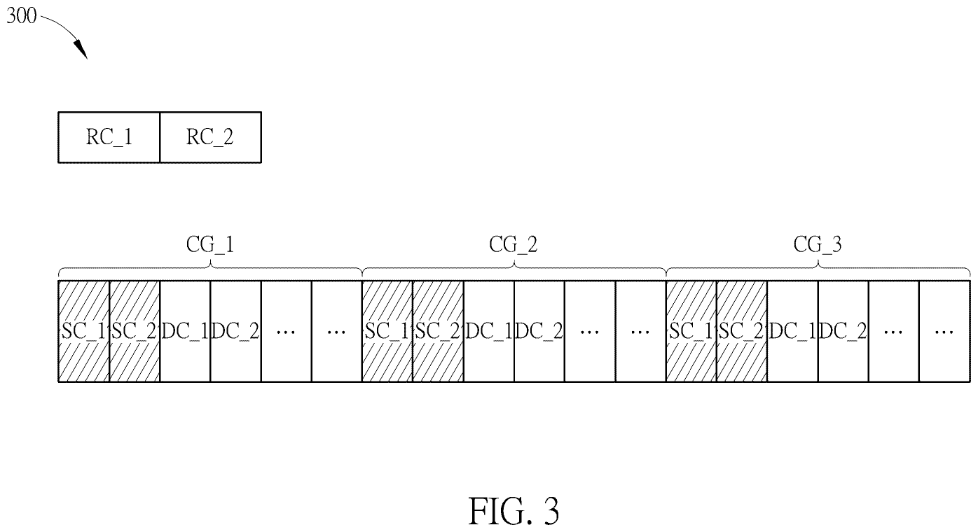

The above-mentioned first macro codes and the second macro codes may be stored in a specific code format. FIG. 3 is a schematic diagram illustrating a code format of the first macro codes according to one embodiment of the present invention. Please note, the second macro codes may also be stored following the code format shown in FIG. 3. As shown in FIG. 3, the code format 300 comprises repeat codes RC_1, RC_2 and code groups CG_1, CG_2, CG_3. The code groups CG_1, CG_2, CG_3 respectively comprises state codes SC_1, SC_2, and definition codes DC_1, DC_2. Please note, the numbers and arrangements of the codes and the code groups are not limited to the example illustrated in FIG. 3.

The repeat codes RC_1, RC_2 represent the number that all code groups CG_1, CG_2, CG_3 are repeatedly executed. For example, if the repeat codes RC_1, RC_2 represent that the repeat time is 3, the code groups CG_1, CG_2, CG_3 are repeated for 3 times. The state codes SC_1, SC_2 mean the states of the first macro steps. The states may mean, for example, at least one button is triggered, at least one program is executed and at least one movement is performed.

The definition codes DC_1, DC_2 mean targets or values of the states. For example, if the state codes SC_1, SC_2 mean at least one button is pressed, the definition codes DC_1, DC_2 specifically define which button is triggered. Similarly, if the state codes SC_1, SC_2 mean at least one program is executed, the definition codes DC_1, DC_2 specifically represent which program is executed. For another example, if the state codes SC_1, SC_2 mean movements are performed, the definition codes DC_1, DC_2 specifically represent values of the movements. In one embodiment, different states of the first macro steps correspond to the definition codes with different data volumes. Further, in one embodiment, the first macro codes further comprise delay codes indicating delays between different ones of the first macro steps.

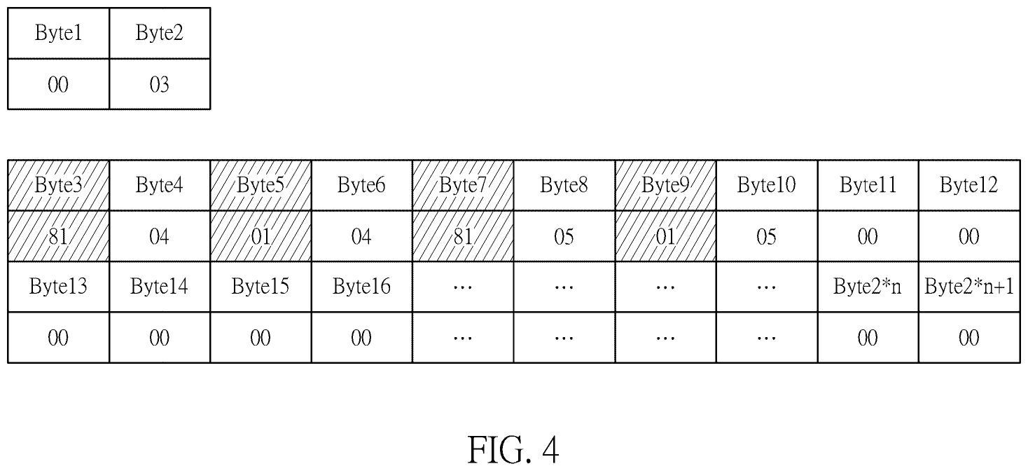

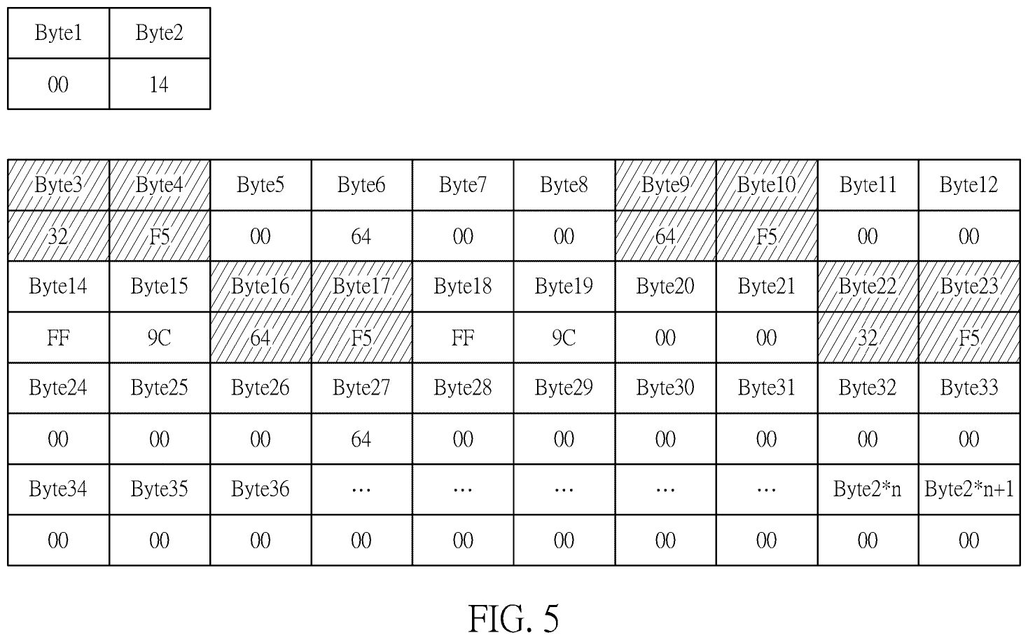

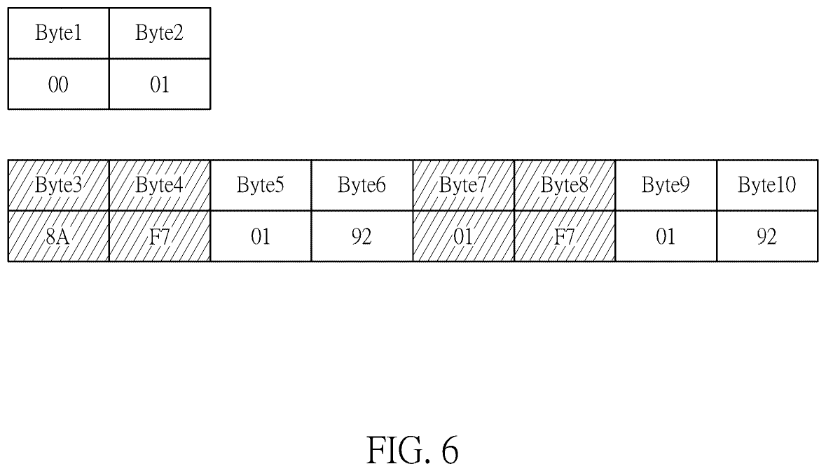

FIG. 4, FIG. 5 and FIG. 6 are examples of first macro codes or second macro codes, according to embodiments of the present invention. The examples in FIG. 4, FIG. 5 and FIG. 6 use Hexadecimal. However, if another carry method is used, the codes may become different. Further, the codes may also be different corresponding to the rules set by the user.

The embodiment of FIG. 4 is a macro provided by a keyboard. In the embodiment of FIG. 4, Byte 1 and Byte 2 are repeat codes, which means 4, thus the macro corresponding to the embodiment of FIG. 4 mean the macro steps corresponding to Byte 3 . . . Byte 2*n+1 are repeated for three times. Also, the value 8 of Byte 3 means “pressing” and the value 1 of Byte 3 means the delay time is 1 ms. Besides, Byte 4 with a value 04 means a key “a”. Additionally, the value 0 of Byte 5 means “releasing” and the value 1 of Byte 3 means the delay time is 1 ms. Besides, Byte 6 with a value 04 means a key “a”. Accordingly, Bytes 3, 4, 5, 6 in FIG. 4 mean the key “a” of the keyboard is pressed and released, and the delay time between “pressing” and “releasing” is 1 ms. In such case, Bytes 3, 4 form a code group and Bytes 5, 6 form another code group.

Following the same way, Bytes 7, 8, 9 and 10 mean the key “b” of the keyboard is pressed and released, and the delay time between “pressing” and “releasing” is 1 ms. Bytes 11 . . . 2*n+1 are all 0 which mean no more macro step is performed. Therefore, the macro show in FIG. 4 means the key “a” of the keyboard is pressed and released, then the key “b” of the keyboard is pressed and released, and such operations are repeated for three times. In the embodiment of FIG. 4, Bytes 3, 5, 7, and 9 comprises the state codes and the delay codes stated in FIG. 3, and Bytes 4, 6, 8, 10 are the definition codes stated in FIG. 3.

The embodiment of FIG. 5 is a macro provided by an optical mouse. In the embodiment of FIG. 5, Byte 1 and Byte 2 are repeat codes, which means 20, thus the macro corresponding to the embodiment of FIG. 5 mean the macro steps corresponding to Byte 3 . . . . Byte 2*n+1 are repeated for 20 times.

Also, the value 32 of Byte 3 means the delay time is 50 ms. Besides, Byte 4 with a value F5 means “mouse X Y movements”. Additionally, the values 00, 64 of Bytes 5, 6 means the values of X movements, and the values 00, 00 of Bytes 7, 8 means the values of Y movements. Accordingly, Bytes 3, 4, 5, 6, 7, 8, which forms a code group, mean mouse X Y movements are (X=100, Y=0) and the delay is 50 ms. In such case, Byte 3 is a delay code, Byte 4 is a state code, and Bytes 5, 6, 7, 8 are definition codes. Following the same rule, the code group comprising bytes 9-15 mean mouse X Y movements are (X=0, Y=−100) and the delay is 100 ms, the code group comprising bytes 16-21 mean mouse X Y movements are (X=−100, Y=0) and the delay is 100 ms, and the code group comprising bytes 22-27 mean mouse X Y movements are (X=0, Y=100) and the delay is 50 ms. Bytes 28 . . . 2*n+1 are all 0 thus no more movement is performed. Therefore, the macro show in FIG. 5 means the optical mouse is moved following the above-mentioned values and directions for 20 times.

The embodiment of FIG. 6 is a macro generated by a host device of the optical mouse 100, such as the computer 101 in FIG. 1. In the embodiment of FIG. 6, Byte 1 and Byte 2 are repeat codes, which mean 1, thus the macro corresponding to the embodiment of FIG. 6 mean the macro steps corresponding to Byte 3 . . . Byte 10 are performed for only one time.

Also, the value 8 of Byte 3 means “pressing” and the value A of Byte 3 means the delay time is 10 ms. Besides, Byte 4 with a value F7 means “consumer”, which means the macro is generated by the host device. Additionally, the values 01, 92 of Bytes 5, 6 means “an icon of a calculator”. Accordingly, Bytes 3, 4, 5, 6 in FIG. 6 mean the calculator is pressing thus being activated, and the delay is 10 ms. In such case, Bytes 3, 4, 5, 6 form a code group.

Following the same rule, the value 0 of Byte 7 means “releasing” and the value 1 of Byte 7 means the delay time is 1 ms. Besides, Byte 8 with a value F7 means “consumer”, which means the macro is generated by the host device. Additionally, the values 01, 92 of Bytes 9, 10 means “an icon of a calculator”. Accordingly, Bytes 7, 8, 9, 10 in FIG. 6 mean the calculator is releasing, and the delay is 1 ms. In such case, Bytes 7, 8, 9, 10 form a code group. In the embodiment of FIG. 4, Bytes 3, 4, 7, and 8 comprises the state codes and the delay codes stated in FIG. 3, and Bytes 5, 6, 9, 10 are the definition codes stated in FIG. 3.

As above-mentioned, the optical mouse 100 may acquire and records the first macro codes, such step may also be named as an encoding operation. Also, the first macro does may be read from the storage device, such step may also be named as a decoding operation. The encoding operation and the decoding operation may be performed by the processing circuit 100_1 illustrated in FIG. 2.

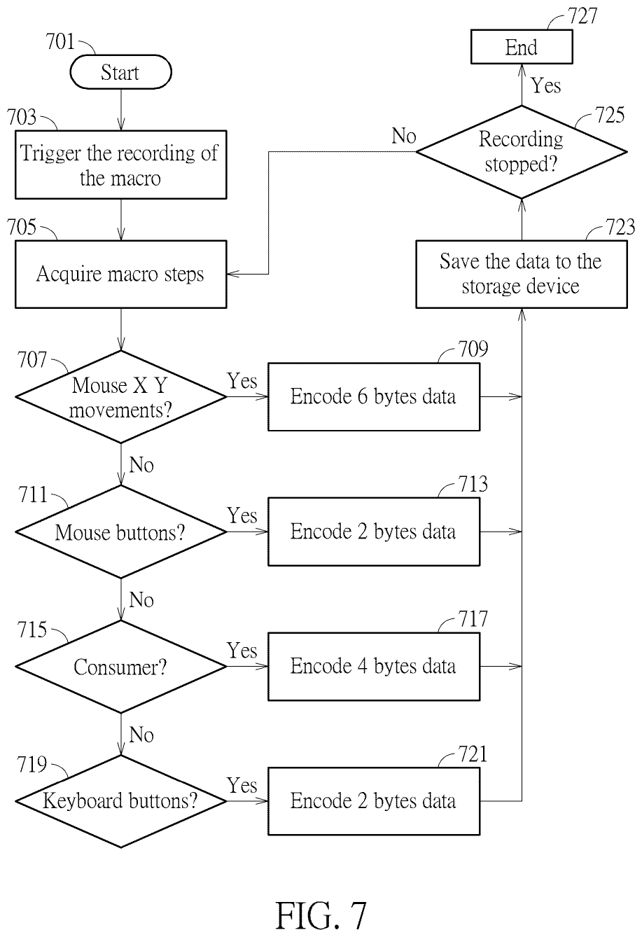

FIG. 7 is a flow chart illustrating an encoding operation according to one embodiment of the present invention, which comprises following steps:

### Step 701

Start.

### Step 703

Trigger the recording of the macro.

For example, two buttons of the optical mouse 100 are pressed to trigger the recording of the macro.

### Step 705

The processing circuit 100_1 acquires signals or codes of the macro steps from the buffer 201 in FIG. 2.

The types of the macro steps may be determined in this step.

### Step 707

Are macro steps the mouse X Y movements? If yes, go to step 709. If not, go the step 711.

### Step 709

Encode 6 bytes data. For example, in the embodiment of FIG. 5, each code group comprises 6 bytes, such as Bytes 3-8, or Bytes 9-15.

### Step 711

Are macro steps the mouse buttons? If yes, go to step 713. If not, go the step 715.

### Step 713

Encode 2 bytes data. For example, in the embodiment of FIG. 4, if the state is using buttons, each code group comprises 2 bytes, such as Bytes 3-4, or Bytes 5-6.

### Step 715

Are macro steps the consumer? If yes, go to step 717. If not, go the step 719.

### Step 717

Encode 4 bytes data. For example, in the embodiment of FIG. 6, each code group comprises 4 bytes, such as Bytes 3-6, or Bytes 7-10.

### Step 719

Are macro steps the keyboard buttons? If yes, go to step 719. If not, go the step 721.

### Step 721

Encode 2 bytes data. For example, in the embodiment of FIG. 4, if the state is using buttons, each code group comprises 2 bytes, such as Bytes 3-4, or Bytes 5-6.

### Step 723

Save the data (the first macro codes or the second macro codes) to the storage device 100_3.

The storage device may be, for example, a memory.

### Step 725

The recording is controlled to be stopped?

For example, a button of the optical mouse 100 is pressed or released to stop recording the macro.

If yes, go to step 727. If not, go back to the step 705.

### Step 727.

End

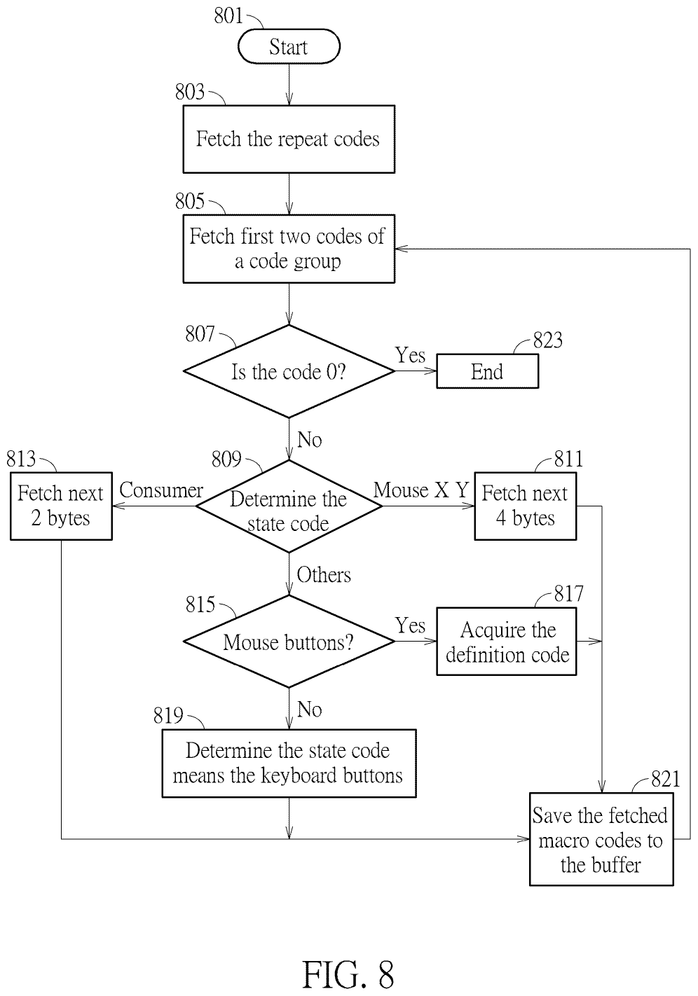

FIG. 8 is a flow chart illustrating a decoding operation according to one embodiment of the present invention, which comprises following steps:

### Step 801

Start.

### Step 803

Fetch the repeat codes.

### Step 805

Fetch first two codes of a code group.

Such step may fetch the states codes and the delay codes, such as Bytes 3, 4 in the embodiments of FIG. 4-FIG. 6.

### Step 807

Determine if the code is 0, which means no macro step is contained. If yes, go to step 823 to end. If not, go to step 809.

### Step 809

Determine the state code.

If the state code means the consumer, go to step 813. If the state code means the mouse X Y movements, go to step 811. If the state code means others, go to step 815.

### Step 811

Fetch next 4 bytes, such as Bytes 5-8 in FIG. 5.

### Step 813

Fetch next 2 bytes, such as Bytes 5-6 in FIG. 6.

### Step 815

Determine if the state code means the mouse buttons. If yes, go to step 817, if not, go to step 819.

### Step 817

Acquire the definition code, such as the Byte 4 in FIG. 4.

### Step 819

Determine the state code means the keyboard buttons.

### Step 821

Save the fetched macro codes to the buffer, such as the buffer 201 in FIG. 2.

In one embodiment, the buffer 201 is a ping-pong buffer for storing the macro steps, the macro codes and the data generated by instant operations of the optical mouse 100. For more detail, the ping-pong buffer comprises at least two buffers, and the macro steps, the macro codes and the data generated by instant operations of the optical mouse 100 are alternatively stored in the buffer, to avoid the collision of different types of data. For example, if the user is moving the optical mouse 100 to control a cursor while the optical mouse 100 recording a macro, the ping-pong buffer is used.

### Step 823

End.

Further, in one embodiment, in order to avoid the collision of different types of data, the optical mouse 100 further performs at least one of following operations while recording the first macro steps: pre-erasing the storage device 100_3, decreasing a report rate of the optical mouse 100, and ignore at least portion of tasks from the computer 101.

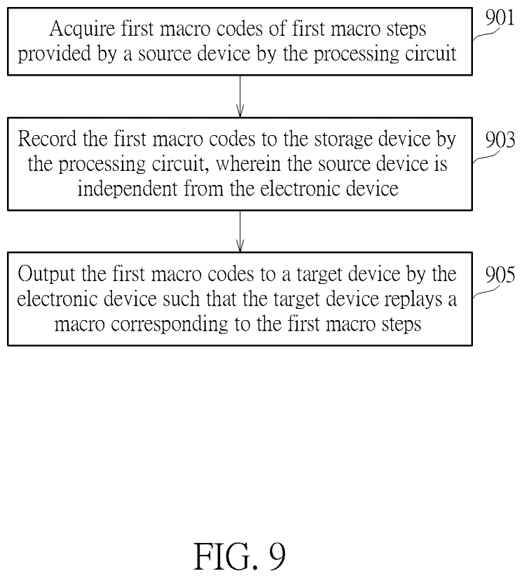

The above-mentioned target device and the source device are not limited to the computer 101 and the keyboard 103 in FIG. 1. Also, the optical mouse 100 may be replaced by any other electronic device. Accordingly, in view of above-mentioned embodiments, a macro recording method can be acquired, which comprises following steps shown in FIG. 9.

FIG. 9 is a flow chart illustrating a macro recording method according to one embodiment of the present invention. The macro recording method is applied to a storage device and a processing circuit and comprises following steps:

Step 901

Acquire first macro codes of first macro steps provided by a source device by the processing circuit.

Step 903

Record the first macro codes to the storage device by the processing circuit, wherein the source device is independent from the electronic device.

For example, the source device is the computer 101 or the keyboard 103 in FIG. 1, which are independent from the optical mouse 100.

Step 905

Output the first macro codes to a target device by the electronic device such that the target device replays a macro corresponding to the first macro steps.

In one embodiment, the target device is the computer 101, and the source device is a HID device such as the keyboard 103. In another embodiment, wherein the target device is the computer 101 and serves as the source device, and the first macro steps are steps for executing at least one program stored in the target device.

In view of above-mentioned embodiments, an electronic device may record macro provided by itself or by another electronic device. By this way, the combinations and application scopes of macros can be extended.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An electronic device, comprising:
a storage device; and
a processing circuit, configured to acquire first macro codes of first macro steps provided by a source device, and configured to record the first macro codes to the storage device, wherein the source device is independent from the electronic device;
wherein the electronic device further outputs the first macro codes to a target device such that the target device replays a macro corresponding to the first macro steps.

2. The electronic device of claim 1, wherein the target device is a computer, and the source device is a HID device which has a wireless connection or a wired connection with the target device.

3. The electronic device of claim 2, wherein the source device is a keyboard.

4. The electronic device of claim 1,
wherein the target device is a computer and serves as the source device;
wherein the first macro steps are steps for executing at least one program stored in the target device.

5. The electronic device of claim 1, wherein the first macro codes comprise state codes indicating states of the first macro steps.

6. The electronic device of claim 5, wherein the first macro codes comprising definition codes indicating targets or values of the states, wherein different states of the first macro steps correspond to the definition codes with different data volumes.

7. The electronic device of claim 5, wherein the first macro codes further comprise delay codes indicating delays between different ones of the first macro steps.

8. The electronic device of claim 1, wherein the processing circuit is further configured to acquire second macro codes of second macro steps performed by the electronic device and configured to record the second macro codes to the storage device.

9. The electronic device of claim 1, wherein the electronic device is an optical mouse which has a wireless connection or a wired connection with a host device, wherein the electronic device further performs at least one of following operations while recording the first macro steps:
pre-erasing the storage device, decreasing a report rate of the optical mouse, and ignore at least portion of tasks from the host device.

10. A macro recording method, applied to an electronic device comprising a storage device and a processing circuit, comprising:
acquiring first macro codes of first macro steps provided by a source device by the processing circuit;
recording the first macro codes to the storage device by the processing circuit, wherein the source device is independent from the electronic device; and
outputting the first macro codes to a target device by the electronic device such that the target device replays a macro corresponding to the first macro steps.

11. The macro recording method of claim 10, wherein the target device is a computer, and the source device is a HID device which has a wireless connection or a wired connection with the target device.

12. The macro recording method of claim 11, wherein the source device is a keyboard.

13. The macro recording method of claim 10,
wherein the target device is a computer and serves as the source device;
wherein the first macro steps are steps for executing at least one program stored in the target device.

14. The macro recording method of claim 10, wherein the first macro codes comprise state codes indicating states of the first macro steps.

15. The macro recording method of claim 14, wherein the first macro codes comprising definition codes indicating targets or values of the states, wherein different states of the first macro steps correspond to the definition codes with different data volumes.

16. The macro recording method of claim 14, wherein the first macro codes further comprise delay codes indicating delays between different ones of the first macro steps.

17. The macro recording method of claim 10, further comprising:
acquiring second macro codes of second macro steps performed by the electronic device by the processing circuit; and
recording the second macro codes to the storage device by the processing circuit.

18. The macro recording method of claim 10, wherein the electronic device is an optical mouse which has a wireless connection or a wired connection with a host device, wherein the macro recording method further performs at least one of following operations while recording the first macro steps:
pre-erasing the storage device, decreasing a report rate of the optical mouse, and ignore at least portion of tasks from the host device.
